(19) United States
(12) Patent Application Publication
(10) Pub. No.: US 2008/0244520 A1
(43) Pub. Date: Oct. 2, 2008

(54) DEVICE AND METHOD FOR AUTOMATICALLY CONFIGURING SOFTWARE

(76) Inventors: Koji Hashimoto, Hitachinaka (JP); Yuichiro Morita, Hitachi (JP); Fumio Narisawa, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/014,892

(22) Filed: Jan. 16, 2008

(30) Foreign Application Priority Data
Mar. 28, 2007 (JP) 2007-083245

(51) Int. Cl. G06F 9/44

(52) U.S. Cl. 717/121

(57) ABSTRACT

An automatic program configuring apparatus capable of facilitating maintenance management of a storage device even when software components stored therein increase in number is disclosed. The apparatus includes a database unit storing software configuration information and software components corresponding to individual items of software component arrangement information which are organized in a tree structure which is represented by a markup language with tags being uniquely definable by a user. The apparatus further includes a configuration information input unit for inputting the software configuration information from the database unit, an interface unit for acceptance of selection of components by the user while displaying a component selection screen based on the input software configuration information, a software component input unit for inputting from the database storage unit software components corresponding to the user's component selection result, and a generator unit for combining together the input software components to generate a software program.

### FIELD OF THE INVENTION

The present invention relates to a method and apparatus for automatically configuring a software program.

### BACKGROUND OF THE INVENTION

Software programs to be built in electronic equipment increase in complexity year by year, resulting in likewise increases in development time period and costs thereof. Under such circumstances, it is useful for system engineers to develop a new software program by combining together the currently existing software components. Further, by selecting time-proven ones of the existing software components, it becomes possible to maintain the quality of a new version of software which was developed by combining them together.

Note however that in cases where mechanical works for combining software components are manually performed by an operator or system designer, it is considered that there are risks which follow: defects can be occurred and mixed due to possible man-caused mistakes. Additionally, when the software components to be combined together increase in number to go beyond several hundreds or more, the mechanical works are no longer readily achievable.

One known automatic program configuring apparatus which combines together the presently available software components to thereby generate source codes of a new software program in an automated way is disclosed, for example, in JP-A-02-105222, which is arranged to include a means for storing therein software component arrangement information as organized in a tree structure, and a means for storing software components corresponding to the individual configuration information elements making up the software configuration information in a tree structure that is the same as the tree structure. By use of these two separate storage means that store the software configuration information and the software components in the same tree structure, it becomes possible to readily specify a software component from among the configuration information elements making up the software configuration information.

Unfortunately, it is a must for the prior art approach to perform maintenance management of the information being stored in each storage means in a way such that the same tree structure is established between the means for storing the software configuration information and the means for storing the software components. When the software components appreciably increase in number, costs needed for such the maintenance management increase accordingly.

### SUMMARY OF THE INVENTION

It is therefore an object of the present invention to make easier the maintenance management with respect to the means for storing software configuration information and software components even when these software components greatly increase in number.

In accordance with one aspect of this invention, a technique for configuring a software program in an automated way is provided. A database storage unit is used to store therein software configuration information and software components corresponding to individual items of software component arrangement information included in the software configuration information in such a manner that these are organized in a single tree structure by means of a markup language with tags being uniquely definable by a user. Based on software configuration information as input from the database storage unit, display a component selection menu on a display screen for permitting a user to choose his or her preferred software components by using an input device. Then, input from the database unit one or more software components corresponding to the user's selection result. Next, combine together these input software components to thereby generate a software program required. Preferably, the component selection result which is accepted from the user is configured into a partial tree by means of the markup language and then output it. Upon receipt of those software components corresponding to this partial tree from the database unit, combine together the input software component to thereby produce a program.

According to the present invention, it is possible to facilitate the maintenance management for the means for storing the software configuration information and software components even when the software components noticeably increase in number.

Other objects, features and advantages of the invention will become apparent from the following description of the embodiments of the invention taken in conjunction with the accompanying drawings.

### BRIEF DESCRIPTION OF THE DRAWINGS

FIG. 1 is a functional block diagram of an automatic software program configuring apparatus in accordance with one embodiment of the present invention.

FIG. 2 shows a hardware configuration of the apparatus of FIG. 1.

FIG. 3 shows one example of a tree structure which is included in a file 151 of FIG. 1, which is named the component arrangement information+software components.xml.

FIG. 4 shows an example of the tree of FIG. 3 which is described by XML.

FIG. 5 shows an example which divides the file shown in FIG. 3 into a plurality of files by using hyper links.

FIG. 6 shows an exemplary component selection display screen of a GUI unit 111 of FIG. 1.

FIG. 7 shows an example of a file named the choice result.xml indicating the contents by a logical tree.

FIG. 8 shows an XML corresponding to FIG. 7.

FIG. 9 shows an example which uses a template engine.

FIG. 10 shows a source file generated by a code generator unit 120.

FIG. 11 shows an example of the component arrangement information +software components.xml file which indicates the contents in the form of a logical tree structure.

FIG. 12 shows an example of the choice result.xml indicating the contents by a logical tree.

FIG. 13 shows a template file in the case of using a template engine.

FIG. 14 shows a source file generated by the code generator unit 120.

FIG. 15 shows a template file in the case of using a template engine.

FIG. 16 shows a source file generated by the code generator unit 120.

FIG. 17 shows a template file in the case of using a template engine.

FIG. 18 shows a source file generated by the code generator unit 120.

FIG. 19 shows a template file in the case of using a template engine.

FIG. 20 shows a source file generated by the code generator unit 120.

### DETAILED DESCRIPTION OF THE INVENTION

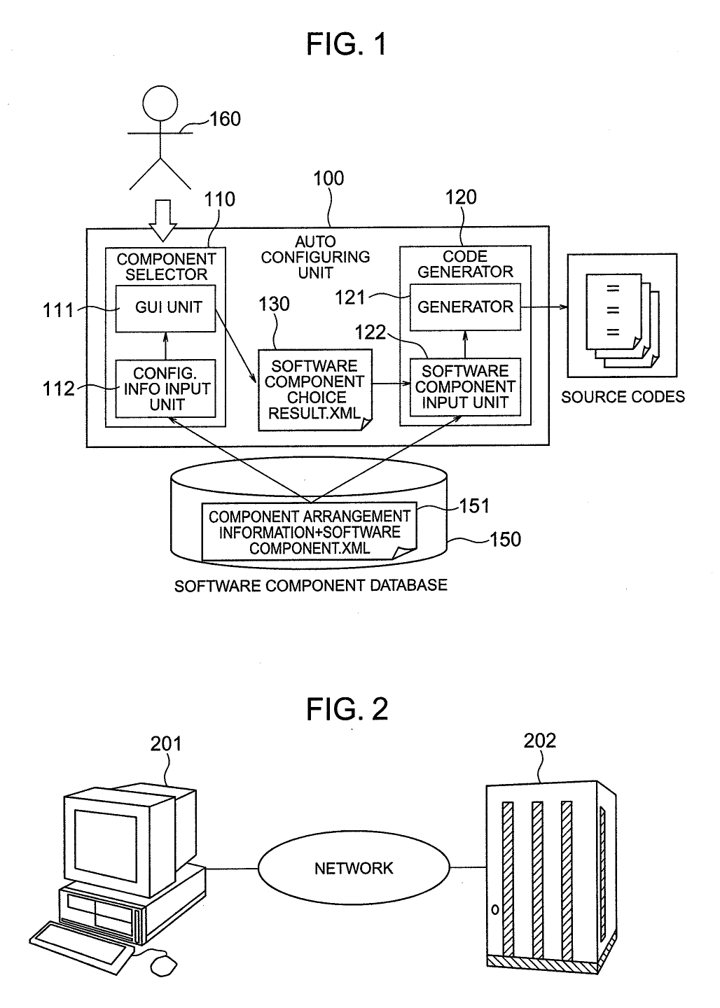

FIG. 1 is a functional block diagram of an automatic software program configuring apparatus in accordance with one embodiment of the present invention. FIG. 2 shows a hardware configuration of FIG. 1.

The automatic software configuring apparatus functions to combine a plurality of software components together to thereby generate a new software program in an automated way, and is arranged to include an automatic configuring unit 100 and a software component database unit 150. In this example, the auto-configuring unit 100 is built in a client computer 201 whereas the software component database 150 is provided in a server 202, although the auto-configuring unit 100 and software component database 150 may be built in the same computer. Alternatively, a component selector unit 110 and code generator unit 120 in the auto-configuring unit 100 may be disposed in different computers, respectively, when the need arises.

The software component database 150 stores therein software configuration information and a plurality of software components. The software configuration information is made up of a plurality of items of software component arrangement information. In the software component database 150, one-to-one correspondence is established between the items of the software component arrangement information and the software components. Each item of the software component arrangement information represents the name and setup parameter(s) of its corresponding software component. A software component indicates either a source file or a partial string of source code characters. In the software component database 150, all of the software components and software component arrangement information are managed in a single tree structure and are stored as a file 151 named “component arrangement information+software components.xml.”

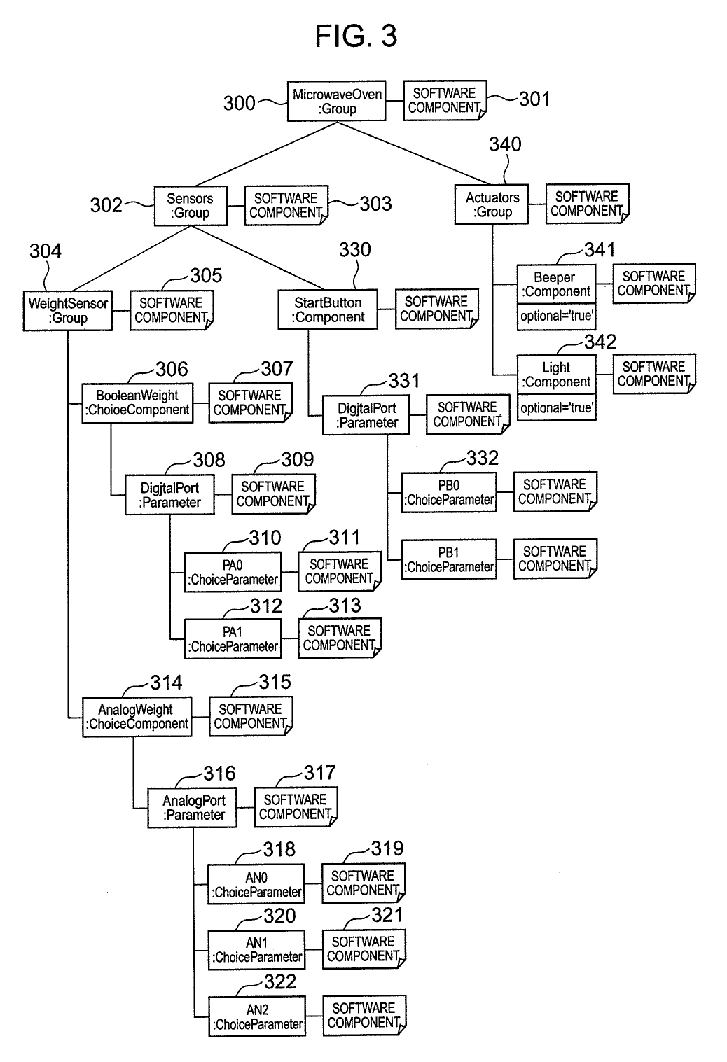

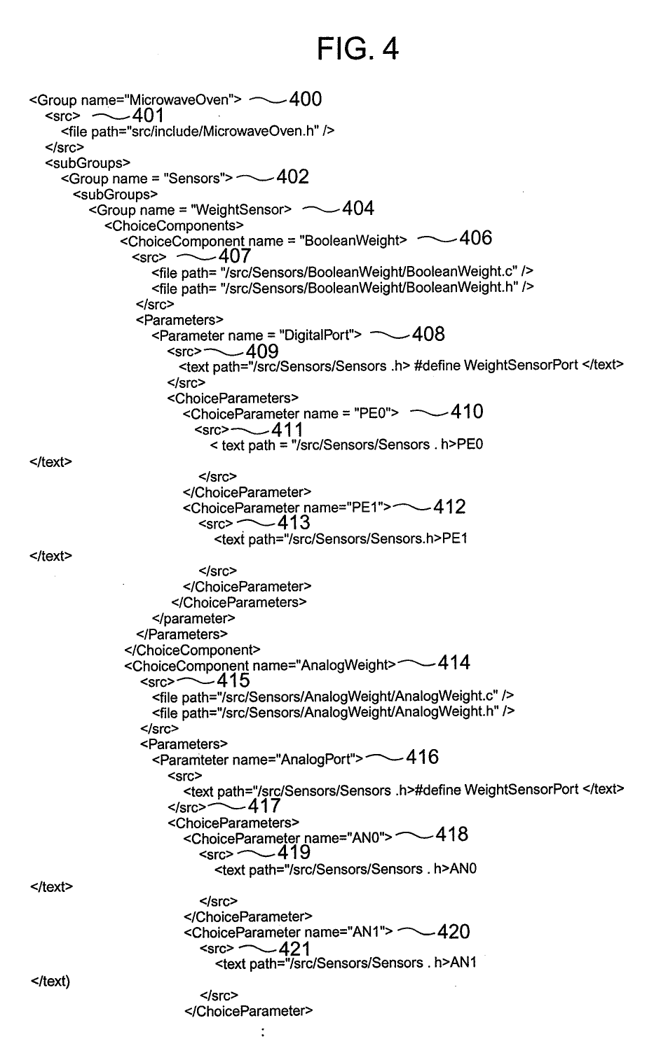

FIG. 3 shows an example of the tree that is included in the component arrangement information+software components.xml file 151 of FIG. 1. FIG. 4 shows an example of the tree of FIG. 3, which is described by the so-called extensible markup language (XML). Although the example using XML is shown herein, any other markup languages which let users create uniquely defined and customized tags may alternatively be employable for the description, such as a standard generalized markup language (SGML) or else.

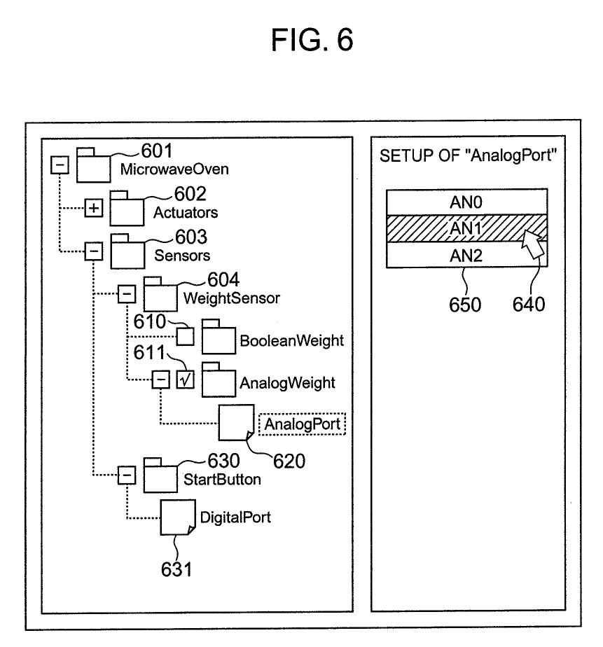

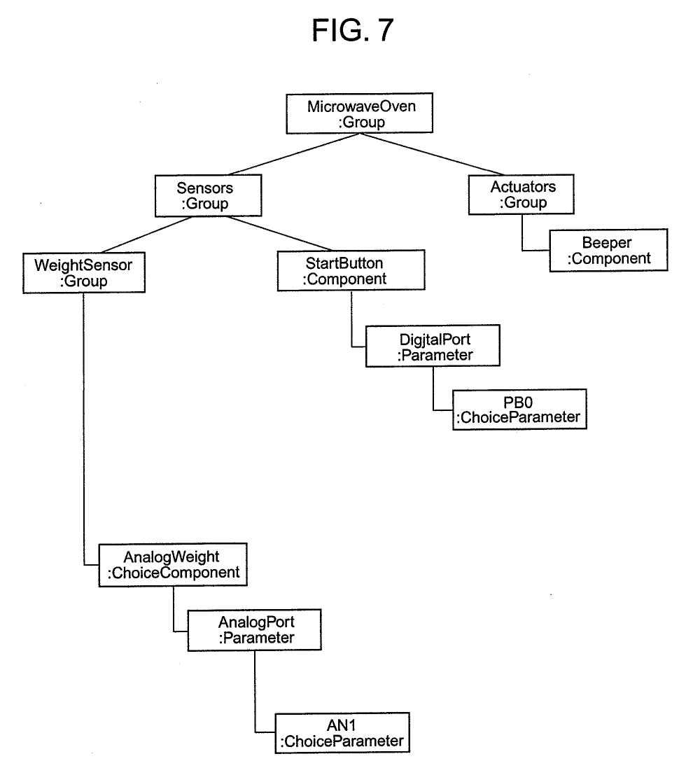

Turning to FIG. 1, the auto-configuring unit 100 is made up of a component selection unit 110 and a code generation unit 120. The component selector unit 110 is constituted from a graphical user interface (GUI) unit 111 and a configuration information input unit 112. The configuration information input unit 112 extracts only the software component arrangement information from the component arrangement information+software components.xml file 151 that is stored in the software component database 150 and outputs the information to the GUI unit 111 functioning as a man-machine interface. The GUI unit 111 displays a component selection menu on a monitor display screen based on the software component arrangement information as input from the configuration information input unit 112. FIG. 6 shows one example of the component selection display screen of the GUI unit 111 of FIG. 1. It accepts choice of a software component or components by a user 160 of the automatic software configuring apparatus. Upon receipt of the choice of such software component(s), the GUI unit 111 outputs such choice result to a file named the software component choice result.xml. FIG. 7 shows in a logical tree form the contents of the software component choice result.xml file in the case where a process includes the steps of selecting a software component “AnalogWeight” from the software component arrangement information shown in FIG. 3, performing parameter setting which sets “AN1” to “AnalogPort,” performing parameter setting which sets “PB0” to “DigitalPort” as a parameter of a software component “StartButton” and selecting a software component “beeper.” As shown in FIG. 7, the GUI unit 111 outputs the software component choice result.xml file in such a way that the tree which is included in the software component choice result.xml file becomes, without fail, a partial tree of the tree which is inherently included in the component arrangement information+software components.xml file 151. Note here that it is not always required that the software component choice result is output to the software component choice result.xml file and may alternatively be output directly to the configuration information input unit 112 as a memory image, such as an object or the like.

The code generator unit 120 is constituted from a generation unit 121 and a software component input unit 122. The software component input unit 122 inputs a software component choice result.xml file 130. Then, based on the tree included in this file, it extracts the selected software components from the component arrangement information+software components.xml file 151 and then outputs them to the generation unit 121. The generation unit 121 appropriately combines together these software components which are input from the software component input unit 122 and then outputs it as a list of compilable source codes.

A detailed explanation will be given of respective units making up the automatic software configuring apparatus of this embodiment below.

Turning back to FIG. 4, an example of the XML description will be described in detail. Here, a part of the XML corresponding to nodes 300 to 321 in the logical tree shown in FIG. 3 is shown for purposes of convenience in illustration and discussion herein.

In FIG. 4, the attributes that are defined in those tags of <Group>, <Component>, <ChoiceComponent>, <Parameter> and <ChoiceParameter> indicate the items of software component arrangement information. For example, at a tag 406 of <ChoiceComponent name=“BooleanWeight”>, the portion “name=“BooleanWeight”” indicates the item of the software component arrangement information. Below is an explanation of each tag.

A <Group> tag is for classification of the software component arrangement information. For example, in FIG. 3, a node 300 corresponds to the <Group> tag 400 in FIG. 4, for defining an oven range system of “MicrowaveOven” per se. More specifically, it is shown in the tree of FIG. 3 that all descendant nodes of the node 300 are either software component arrangement information or software components concerning the microwave oven range system. In addition, nodes 302 and 340 show that the software component arrangement information concerning the oven range system are classified into “Sensors” and “Actuators.” Introducing the generation unit tags as shown in FIG. 4 makes it possible to represent the embedded structure of these generator unit tags. And, it is defined by nodes 304 and 330, 341, 342 that software components “WeightSensor” and “StartButton” belong to the category “Sensors” whereas software components “Beeper” and “Light” belong to the category “Actuators.”

A <Component> tag is for defining the configuration information corresponding directly to software components. For example, in FIG. 3, a node 330 defines software component arrangement information concerning buttons categorized as “SlantButton”. Additionally, “optional=“true”” is defined in nodes 341 and 342 as the software component arrangement information. This indicates that the functions of such software components corresponding to the both nodes are optional. On the other hand, the node 330 has no such definition. Accordingly, it is defined that “StartButton” is not optional but essential for the functionality of the oven range system.

A <ChoiceComponent> tag is the one that defines configuration information directly corresponding to a software component-more precisely, this tag is for defining alternatives or options of a software component. For example, in FIG. 3, the nodes 304 and 306, 314 permit “BooleanWeight” and “AnalogWeight” to be defined in the software component of “WeightSensor” as selectable options thereof. Whereby, it is defined that either one of the software components “BooleanWeight” and “AnalogWeight” should be chosen as the “WeightSensor.” More precisely, the node 306 corresponds to the <ChoiceComponent> tag 406 in FIG. 4 for defining the software component arrangement information as to a weight sensor in the oven system in the category of “BooleanWeight.” By the <ChoiceComponent> tag, a software component of “BooleanWeight” out of available weight sensors is defined as one of the user's selectable options. In addition, the node 314 corresponds to a <ChoiceComponent> tag 414 in FIG. 4, for defining software component arrangement information as to a weight sensor in the category of “AnalogWeight.” By the <ChoiceComponent> tag, a software component of “AnalogWeight” out of the weight sensors is defined as one of the existing options.

A <Parameter> tag is to define setup parameters of a software component. A <ChoiceParameter> tag defines options of the setup contents in the parameter. For example, in FIG. 3, a node 308 corresponds to a <Parameter> tag 408 in FIG. 4, for defining “DigitalPort” as a setup parameter of the “BooleanWeight” node 306. The nodes 310 and 312 correspond to <ChoiceParameter> tags 410 and 412 in FIG. 4, respectively, for defining “PA0” and “PA1” as options of the setup contents of this parameter.

In contrast, a portion residing between a <src> tag and a </src> tag indicates a software component. In the <src> and </src> tags, either <file> tag or <text> tag is insertable. A portion which is interposed between <file> and </file> tags indicates a source code-described file per se as a software component whereas a portion residing between <text> and </text> tags indicates as a software component a string of characters which become a partial source code and the path name of a file into which the character string is to be inserted. An example is that in FIG. 4, source code-described files “/src/Sensors/BooleanWeight/BooleanWeight.c” and “/src/Sensors/BooleanWeight/BooleanWeight.h” are indicated as software components in a <src> tag 407 immediately below the <ChoiceComponent> tag 406. In addition, in a <src> tag 409 immediately beneath the <Parameter> tag 408, a software component is indicated, which has a file path name of “/src/Sensors/Sensors.h” into which a source code character string is to be inserted, wherein this character string is “#define WeightSensorPort.” By introduction of the <file> and <text> tags in the way stated above, it becomes possible for the generation unit 121 to perform processing while distinguishing over each other the one that deals with a file per se as a software component and the one that deals with a source code character string as a software component.

Also importantly, by interposing the <src> tag between any two of the <Component>, <Parameter> and <ChoiceParameter> tags, a one-to-one correspondence relationship is established for software components and the software component arrangement information corresponding to these software components. For example, in FIG. 4, by letting a file “/src/Sensors/BooleanWeight/BooleanWeight.c” be interposed within the <src> tag 407 while at the same time causing the same <src> tag to be interposed immediately below the <ChoiceComponent> tag 406, one-to-one correspondence is established between the software component arrangement information of “BooleanWeight” and the software component “/src/Sensors/BooleanWeight/BooleanWeight.c.”

Note here that a software component is also definable within the <src> tag 401 residing just beneath the <Group> tag 400, for example. As previously stated, the <Group> tag 400 is the one that defines the oven range system of “MicrowaveOven” per se. Accordingly, defining a software component in the <src> tag 401 makes it possible to define the same software component as a common software component in an entirety of the microwave oven system. By enabling definition of the <src> tag immediately below the <Group> tag also, it is possible to define more than one common software component between the software components.

With the arrangement above, it becomes possible for the configuration information input unit 112 to extract only the software component arrangement information by paying attention to the <Group> tag and the <Component>, <ChoiceComponent>, <Parameter> and/or <ChoiceParameter> tag. Regarding the software component input unit 122, it becomes possible to extract a software component which corresponds to each item of the software component arrangement information by paying attention to the <src> tag.

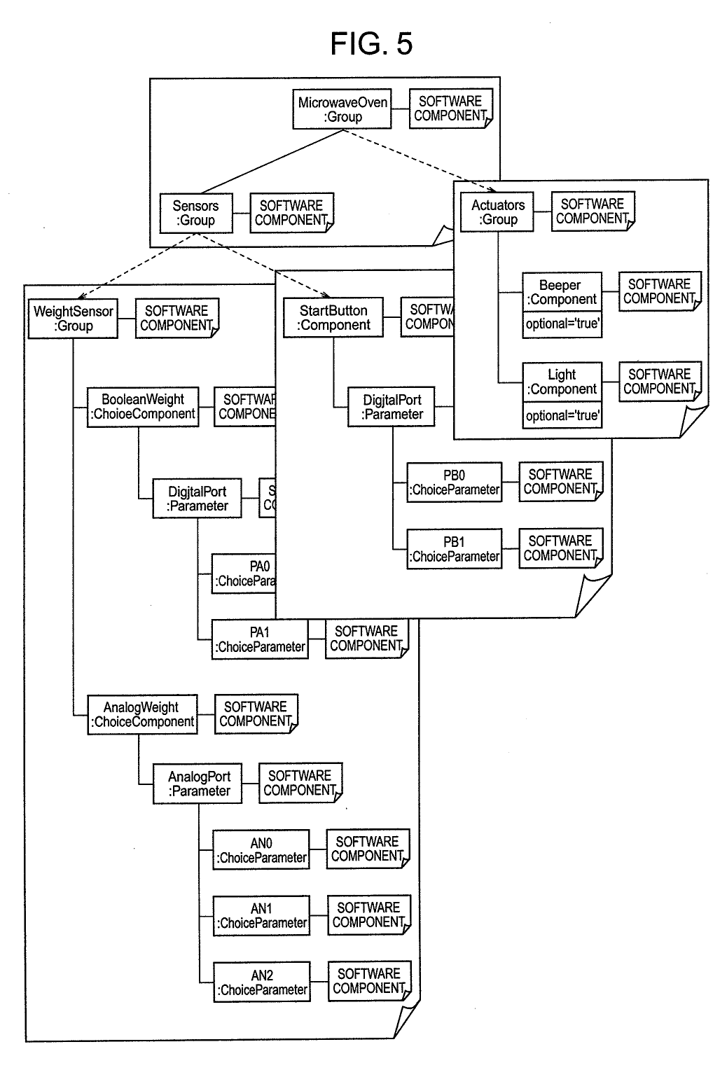

The above-noted tree that is described in the component arrangement information+software components.xml file 151 may be a single one in a logical sense: the tree may be divided into parts which are described in a plurality of files in a physical sense. For example, as shown in FIG. 5, it is also possible to describe by using hyper links the software components and software component arrangement information in a plurality of physically separate files which are organized logically in a single tree structure.

The configuration information input unit 112 inputs the component arrangement information+software components.xml file 151 and then extracts therefrom only the software component arrangement information for output to the GUI unit 111. More practically, the configuration information input unit 112 extracts only the software component arrangement information by referring to the <Group> tag and the <Component>, <ChoiceComponent>, <Parameter> and/or <ChoiceParameter> tag.

The GUI unit 111 inputs the software component arrangement information from the configuration information input unit 112 and then visually displays on a display screen a component select menu based on the same information. An example is that upon input of the software component arrangement information shown in FIG. 3 (or FIG. 4), the GUI unit 111 displays a component choice screen such as shown in FIG. 6. The user 160 of the automatic software configuring apparatus operates the same screen by use of a mouse pointer 640 to thereby make his or her choice of a software component(s) and also perform parameter setup.

The GUI unit 111 performs a tree displaying operation based on the software configuration information in a way which follows. One or more nodes which are defined by the <Group> tag are displayed in the form of contents-expandable folders, such as those indicated by icons 601, 602, 603 and 604 in FIG. 6. Regarding a node which is defined by the <Component> tag, if the attribute “optional” is not defined thereto, the tag is displayed as a contents-expandable folder, such as an icon 630 in FIG. 6. As for nodes defined by the <Component> and <ChoiceComponent> tags with the attribute being defined to be “true,” check boxes 610 and 611 are displayed to thereby indicate that their corresponding software components are optional or alternative. For nodes each corresponding to the <Parameter> tag, icons 620 and 631 are used for distinguishing them from the others. When clicking on the icon 620 or 631, a group of nodes corresponding to the <ChoiceParameter> tag is displayed as an option for parameter choice. As an example, FIG. 6 shows a display screen in case a click is made on the “AnalogPort” 620. Here, nodes 318, 320 and 322 residing in a lower hierarchical level of the node 316 in FIG. 3 are displayed as a parameter choice screen indicated by reference numeral 650 in FIG. 6.

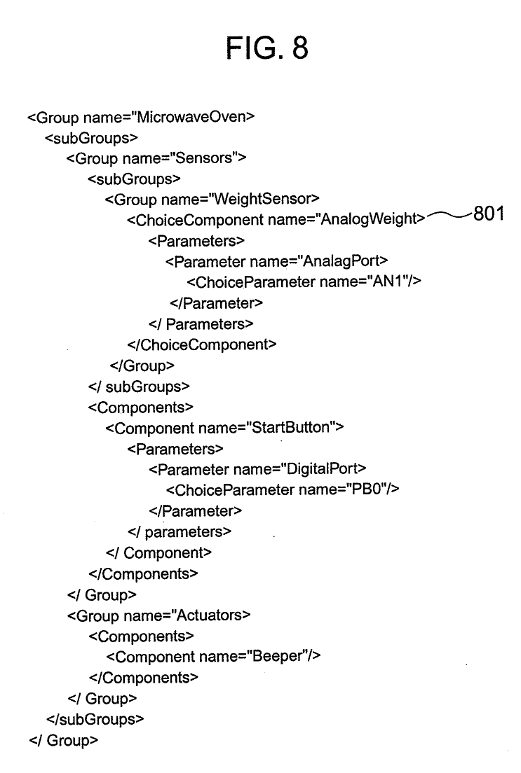

Upon receipt of software component choice and/or parameter setup from the user 160 of the automatic software configuring apparatus via the component choice screen shown in FIG. 6, the GUI unit 111 outputs such received result as a software component choice result.xml file 130. FIG. 7 shows in the form of a logical tree an example of the contents of such software component choice result.xml file 130 in the case where the user 160 has selected a software component “Beeper” while selecting “AnalogWeight” as the software component “WeightSensor,” performing its parameter setup for setting “AN1” to “AnalogPort,” and setting “PB0” to “DigitalPort” as parameter setup of “StartButton.” In this way, the GUI unit 111 outputs the software component choice result.xml file 130 in such a manner as to become a partial tree of the logical tree of the software component arrangement information as input from the configuration information input unit 112. To do this, it is necessary, when a software component corresponding to a certain node is chosen, to include in the same file all the ascendant nodes which contain a parent of such the node. An exemplary description of XML file corresponding to the tree of FIG. 7 is shown in FIG. 8.

The software component input unit 122 inputs the software component choice result.xml file 130 and specifies the selected software component(s) by referring to the <src> tag in the component arrangement information+software components.xml file 151. More specifically, when this file 151 is stored in XML database, it is possible to specify the target software component by use of XML Path (XPath) or XML Query (XQuery).

In case XPath is used for example, software component identification is enabled in a way which follows. Consider the component arrangement information+software components.xml file 151 shown in FIG. 3 (or in FIG. 4) and the software component choice result.xml file 130 shown in FIG. 7 (or FIG. 8). The software component input unit 122 tracks or “traces” the tree of the software component choice result.xml file 130 from its route node toward a leaf node to thereby perform for each node the following processing.

Firstly at step 1, obtain XPath of a presently visiting node. For example, when presently visiting at a node which corresponds to a <ChoiceComponent name=“AnalogWeight”> tag 801 in FIG. 8, its XPath becomes: “/Group[attribute::name=“MicrowaveOven”]/subGroups/Group [attribute::name=“Sensors”]/subGroups/Group[attribute:: name=“WeightSensor”]/ChoiceComponent[attribute::name=“AnalogWeight”]”.

Then, at step 2, add “/src” to the tail end of the XPath thus obtained at the step 1. Whereby, the XPath becomes: “/Group[attribute::name=“MicrowaveOven”]/subGroups/Group [attribute::name=“Sensors”]/subGroups/Group[attribute:: name=“WeightSensor”]/ChoiceComponent[attribute::name=“AnalogWeight”]/src”.

At step 3, use the XPath obtained at the step 2 to search inside of the component arrangement information+software components.xml file shown in FIG. 4, which is stored in the XML database. Thus it is possible to specify character strings that are interposed by the <src> tag 415: <file>/src/Sensors/AnalogWeight/AnalogWeight.c</file>, and <file>/src/Sensors/AnalogWeight/AnalogWeight.h</file>. In this way, the software component is able to be extracted, which is in one-to-one correspondence with the software component arrangement information of <ChoiceComponent name=“AnalogWeight”>.

In the way stated above, it is possible to extract every necessary software component by performing the above-stated processing while at the same time tracking the logical tree of the software component choice result.xml file 130 from its route node toward a leaf node. Then, the software component input unit 122 outputs the extracted software components to the generation unit 121.

The generation unit 121 combines together the software components as input from the software component input unit 122 and then outputs a combined result as a source file. In case the input software component is absolutely a file per se, this file will be output directly as a source file, without change. As in the component arrangement information+software components.xml file 151 shown in FIG. 4, it is possible to define only the path name of a file that is a software component and then store the entity of such file in the database individually. It is also possible to include the entire contents of such file that is a software component in the component arrangement information+software components.xml file 151.

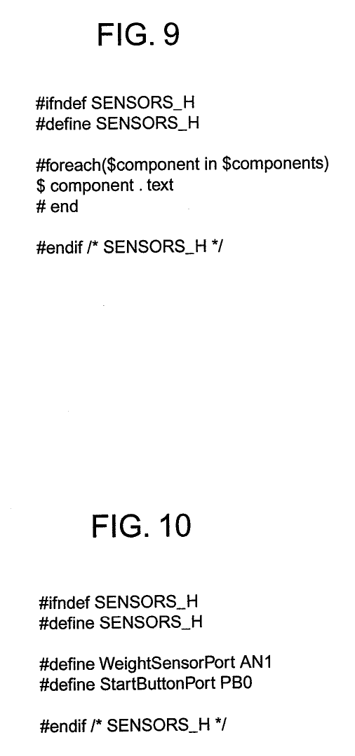

Alternatively, in a case where the software component which was input by the generation unit 121 is a string of source code characters, it is necessary for the generation unit 121 to insert this character string into the designated file. Here, it is also possible to prepare in advance a template of such file of insertion. FIG. 9 shows, as an example of the template of the insertion file, a template of “/src/Sensors/Sensors.h” file in the case of using Velocity (http://jakarta.apache.org/velocity/), which is a template engine. In FIG. 9, an insertion location of the character string is defined as “$component.context.” In Velocity, use of the directive “#foreach” makes it possible to insert a plurality of character strings in a sequential way as shown in FIG. 9. For example, consider the case where the software component choice result.xml file shown in FIG. 7 or FIG. 8 is input to the software component input unit with respect to the component arrangement information+software components.xml file shown in FIG. 3 or 4. At this time, attention is taken to those software components corresponding to the nodes 316, 320 and 331-332 out of the software components to be identified by the software component input unit 122. Suppose that these software components are with designation of a common insertion destination file “/src/Sensors/Sensors.h” and are source code character strings of “#define WeightSensorPort”, “AN1¥n”, “#define StartButtonPort” and “PB0¥n” respectively, where “¥n” is a character indicative of line feed (LF). The generation unit 121 that has input these four source code character strings from the software component input unit 122 uses the Velocity to insert them into the template file shown in FIG. 9 in a sequential way to thereby generate a source file shown in FIG. 10.

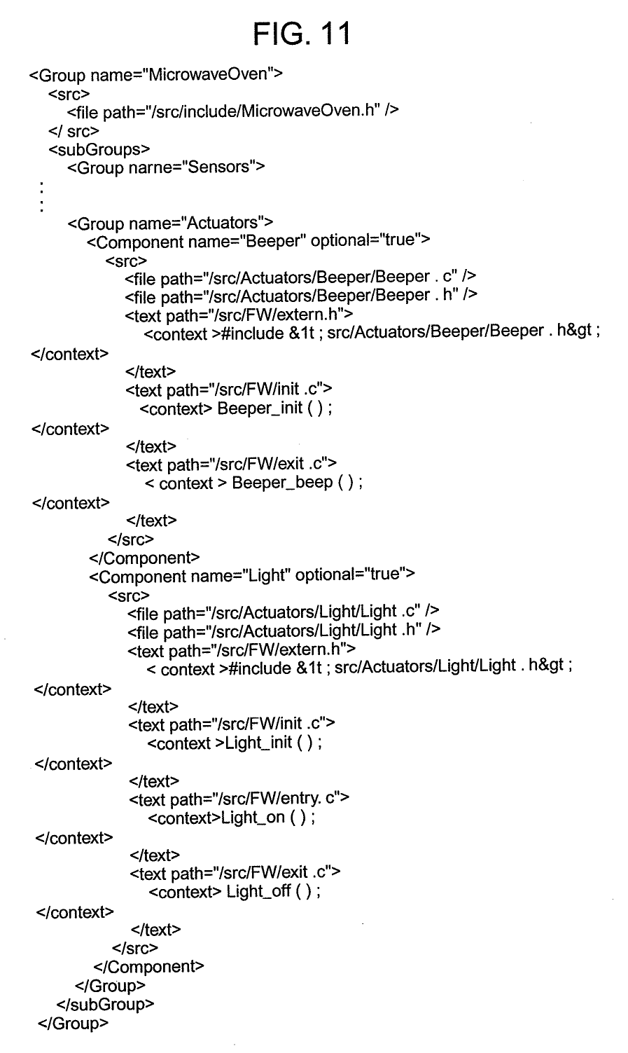

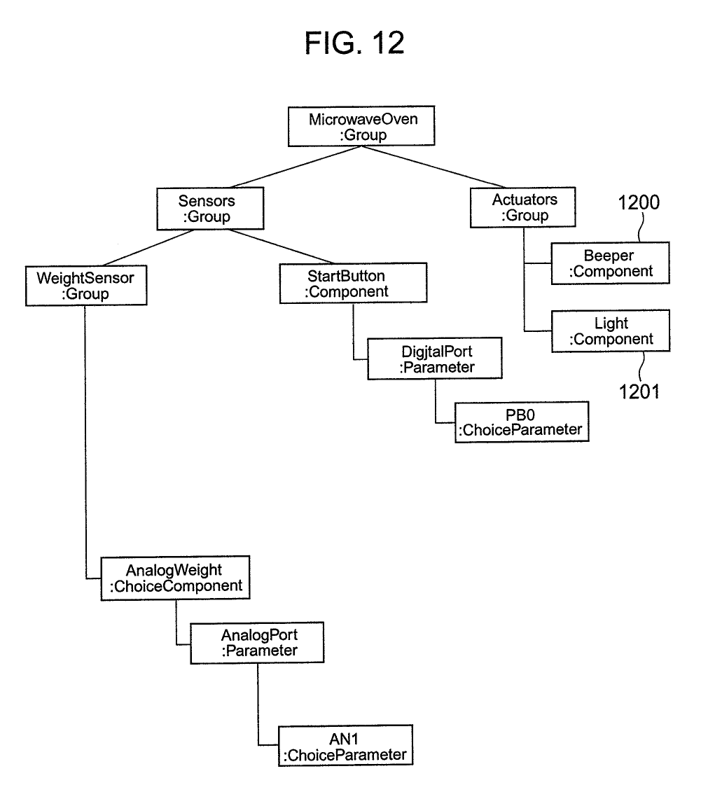

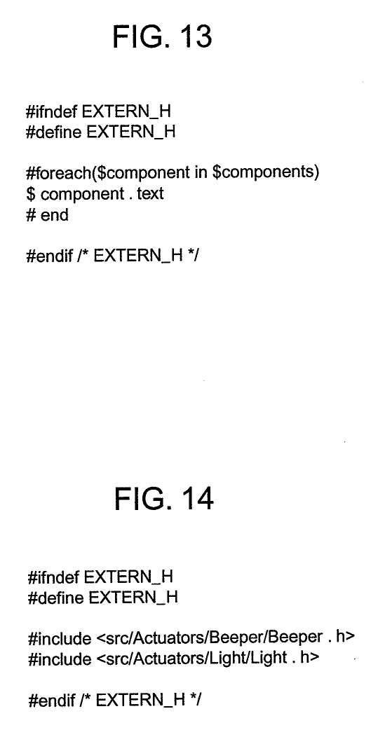

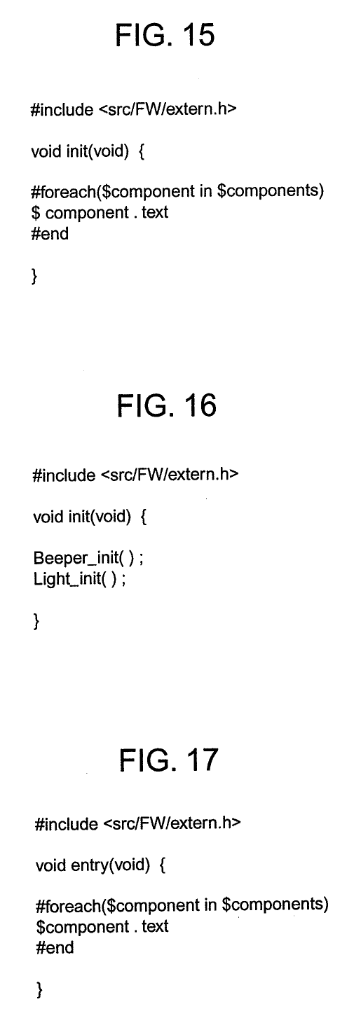

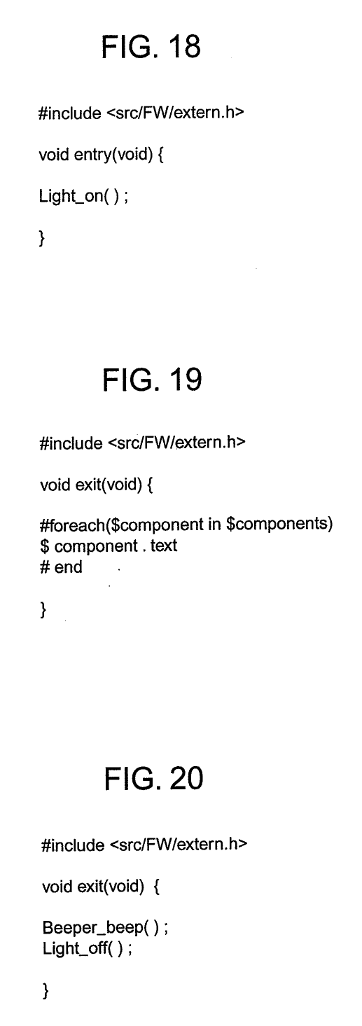

FIG. 11 shows XML corresponding to a partial tree at a level lower than the node 340 in FIG. 3. Here, consider the case where the software component choice result.xml file shown in FIG. 12 is input to the software component input unit 122 with respect to the component arrangement information +software component.xml file shown in FIG. 11. In this case, when looking at nodes 1200 and 1201 in FIG. 12, it can be seen that optional software components “Beeper” and “Light” are presently chosen. The software components specified by the software component input unit 122 include software components corresponding to the software components “Beeper” and “Light” in which “/src/FW/extern.h”, “src/FW/init.c”, “/src/FW/entry.cc” and “/src/FW/exit.c” are defined as source code character string insertion destination files as shown in FIG. 11. Template files of the above-noted files are shown in FIGS. 13, 15, 17 and 19, respectively. As apparent from FIG. 11, the generation unit 121 generates source files shown in FIGS. 14, 16, 18 and 20 by inserting source code character strings “#include <src/Actuators/Beeper/Beeper.h” and “#include <src/Actuators/Light/Light.h” into an insertion destination file “/src/FW/extern.h,” inserting source code character strings “Beeper_init( );¥n” and “Light_init( );¥n” into an insertion destination file “/src/FW/init.c,” inserting a source code character string “Light_on( );¥n” into an insertion destination file “/src/FW/entry.c” and inserting source code character strings “Beeper_beep( );¥n” and Light_off( );¥n” into an insertion destination file “/src/FW/exit.c.”

It should be further understood by those skilled in the art that although the foregoing description has been made on embodiments of the invention, the invention is not limited thereto and various changes and modifications may be made without departing from the spirit of the invention and the scope of the appended claims.

1. An automatic program configuring apparatus comprising:
a database storage unit storing therein software configuration information and software components corresponding to individual items of software component arrangement information included in the software configuration information, which are structured in a single tree structure by means of a markup language with tags being uniquely definable by a user;
a configuration information input unit operative to input the software configuration information from said database storage unit;
an interface unit for acceptance of selection of components by the user while displaying a component selection screen based on the software configuration information as input by said configuration information input unit;
a software component input unit for inputting from said database storage unit software components corresponding to the result of the component selection accepted from the user at said interface unit; and
a generator unit for combining together the software components as input at said software component input unit to thereby generate a program.

2. An automatic program configuring apparatus according to claim 1, wherein said interface unit arranges the result of the component selection accepted from the user as a partial tree by means of the markup language and outputs the same, and
said software component input unit inputs from said database storage unit software components corresponding to the partial tree arranged by said interface unit.

3. An automatic program configuring apparatus according to claim 1, wherein said database storage unit stores the software components while causing a software component in common to a plurality of lower parts of the software component arrangement information in said tree structure to correspond to an upper part of said software component arrangement information.

4. An automatic program configuring apparatus according to claim 2, wherein said database storage unit performs storage while causing a software component in common to a plurality of lower part of said software component arrangement information in said tree structure to correspond to the upper part of said software component arrangement information, and
said generator unit extracts the software components from the upper part of said software component arrangement information while simultaneously tracking the lower part of said software component arrangement information and then combines them together to thereby generate said program.

5. An automatic program configuring apparatus according to claim 1, wherein said generator unit combines together software components as input by said software component input unit and outputs the combined components as a compilable source code.

6. An automatic program configuring apparatus according to claim 1, wherein said database storage unit stores while mutually correlating a plurality of files which form a partial tree in said tree structure.

7. An automatic program configuring apparatus according to claim 1, wherein said database storage unit stores as said software configuration information the software component arrangement information to be selected essentially and the software component arrangement information to be selected arbitrarily while distinguishing one from the other.

8. An automatic program configuring apparatus according to claim 1, wherein said interface unit displays in a folder form a hierarchy based on the tree structure of said database storage unit.

9. An automatic program configuring apparatus according to claim 1, wherein said database storage unit contains a classification tag or tags as said software configuration information.

10. An automatic program configuring apparatus according to claim 1, wherein said database storage unit contains as said software configuration information a tag for defining configuration information corresponding directly to a software component.

11. An automatic program configuring apparatus according to claim 1, wherein said database storage unit contains as said software configuration information a tag for defining an option of a software component.

12. An automatic program configuring apparatus according to claim 1, wherein said database storage unit contains as said software configuration information a tag for defining a setup parameter of a software component.

13. An automatic program configuring apparatus according to claim 1, wherein said database storage unit contains as said software configuration information a tag for defining an option of setup contents at a setup parameter of a software component.

14. An automatic program configuring apparatus according to claim 1, wherein said database storage unit contains as said software configuration information a tag for defining a file with a software component source code being described therein.

15. An automatic program configuring apparatus according to claim 1, wherein said database storage unit contains as said software configuration information a tag for defining a string of characters for use as a source code of software component and a file path name into which the string of characters is to be inserted.

16. An automatic program configuring apparatus according to claim 1, wherein the software configuration information includes a configuration information element indicative of classification of configuration information, a configuration information element indicative of a software component and a configuration information element indicating a setup parameter of software component, being stored separately in said database storage unit.

17. An automatic program configuring apparatus according to claim 1, wherein said interface unit displays an element indicative of classification of said configuration information as a classification indicating information, displays an element indicating the software component as a software component, and displays an element indicative of a setup parameter of said software component as a setup parameter.

18. An automatic program configuring method comprising the steps of:
inputting software configuration information from a database storage unit storing therein the software configuration information and software components corresponding to individual items of software component arrangement information included in the software configuration information, which are structured in a single tree structure by means of a markup language with tags being uniquely definable by a user;
displaying a component selection screen based on the input software configuration information for permitting selection by a user using an input device;
inputting software components corresponding to a result of the selection; and
combining the input software components together to thereby generate a program.
